(19) United States
(12) Patent Application Publication
(10) Pub. No.: US 2004/0162785 A1
(43) Pub. Date: Aug. 19, 2004

(54) Methods and apparatus for determining digital copy protection levels assigned to services received at a consumer appliance

(75) Inventor: Christopher J. Stone, Newtown, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/368,844

(22) Filed: Feb. 19, 2003

(51) Int. Cl. G06F 17/60

(52) U.S. Cl. 705/57

(57) ABSTRACT

The present invention provides methods and apparatus for determining digital copy protection levels assigned to received services. A consumer terminal in accordance with the invention includes memory for storing data which defines a set of service tiers. Each service tier is associated with one of a plurality of copy protection levels. A parser is provided for parsing service information from a received service to enable determination of the service tier associated with the received service. A processor is provided for matching the service tier of the received service with its associated copy protection level. A copy protection system enables copy protection for the received service in accordance with the copy protection level associated with the received service.

### BACKGROUND OF THE INVENTION

The present invention relates generally to the field of digital copy protection. More specifically, the present invention provides methods and apparatus for determining digital copy protection levels assigned to services received at a consumer appliance, such as a television terminal or the like. The methods and apparatus of the present invention provide an alternative means for defining digital copy protection levels for devices that do not have the means to receive such information from an authoritative source (e.g., a system operator's conditional access system or the like).

Copy protection is intended to protect digital content from being illegally copied and distributed. This may be done at two stages by: (1) preventing illegal copying and controlling how many copies are made; (2) preventing access to transferred bits and preventing theft of content while bits are being transferred. Examples of digital content copy protection include Digital Transmission Content Protection (DTCP) and High-bandwidth Digital Content Protection (HDCP).

There is currently no way to set copy protection levels for digital services distributed on legacy systems. Such legacy systems include cable, satellite and off-air television systems which do not include built-in copy protection capabilities.

It would be advantageous to enable copy protection on legacy systems. It would be further advantageous to enable copy protection by associating a program tier level with a copy protection level at the consumer appliance.

The methods and apparatus of the present invention provide the foregoing and other advantages.

### SUMMARY OF THE INVENTION

The present invention provides methods and apparatus for determining digital copy protection levels assigned to services received at a consumer appliance. In accordance with the invention, a set of service tiers is defined. Each service tier is associated with one of a plurality of copy protection levels. Service information is parsed from a received service to enable determination of the service tier associated with the received service. The service tier of the received service is then matched with its associated copy protection level. Copy protection for the received service may then be enabled in accordance with the copy protection level associated with the received service.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows a block diagram of a further example embodiment of the invention; and

FIG. 3 shows an example service tier/copy protection level look-up table.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

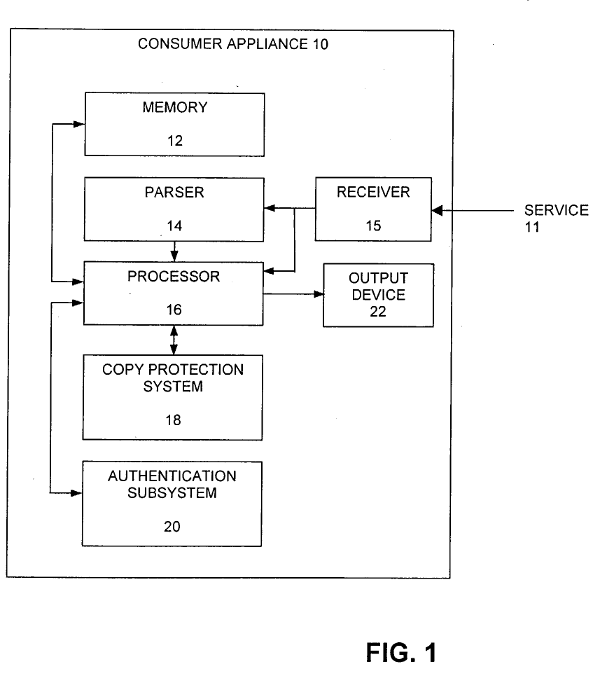

The present invention provides methods and apparatus for determining digital copy protection levels assigned to received services. As shown in FIG. 1, an example embodiment of a consumer appliance 10 in accordance with the invention may include memory 12 for storing data defining a set of service tiers. Each service tier may be associated with one of a plurality of copy protection levels, as illustrated, e.g., in FIG. 3. A service 11 is received at a receiver 15. A parser 14 may be provided for parsing service information from a received service 11 to enable determination of the service tier associated with the received service 11. A processor 16 may be provided for matching the service tier of the received service 11 with its associated copy protection level. A copy protection system 18 may enable copy protection for the received service 11 in accordance with the copy protection level associated with the received service 11.

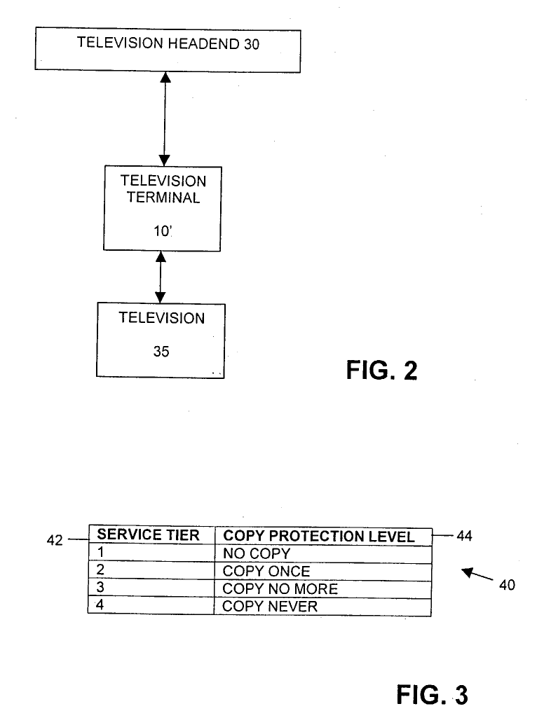

An output device 22 may be provided for output of the received service after copy protection is enabled. The output device 22 may comprise, for example, a speaker and/or a display of the consumer appliance 10. Alternatively, the output device 22 may provide a link to a separate device for audio and/or video playback of the received service, which separate device may be authenticated via the authentication subsystem 20 (as described below in connection with FIG. 2).

The service 11 may comprise a television program, a pay-per-view event, an on-demand program, streaming media, IP data, a downloadable software program, a song, a multimedia file, a music video, or the like.

The consumer appliance 10 may comprise a television terminal, a digital television, a personal computer, an Internet appliance, a personal digital assistant, a telephone, or the like.

The service information may comprise at least one of channel map information, program guide information, or the like.

The parser 14 may parse the service information when the consumer appliance is tuned to output the received service.

The copy protection enabled by the copy protection system 18 may comprise at least one of Digital Transmission Content Protection (DTCP) copy protection, High-bandwidth Digital Content Protection (HDCP) copy protection, or the like.

In one exemplary embodiment of the invention as shown in FIG. 2, the consumer appliance may comprise a television terminal 10′. In such an embodiment, the service (received from a television headend 30) may comprise a television program. The set of service tiers may be defined at either the television headend 30 or at the television terminal 10′. It should be appreciated that the television terminal 10′ and the television 35 may be separate devices, as illustrated in FIG. 2, or may be combined into a single unit. In the latter case, the television terminal components would be incorporated into the television 35.

An authentication subsystem 20 (see FIG. 1) may be provided for establishing authentication between the television terminal 10′ and a digital television 35. The authentication subsystem 20 ensures the identity, authenticity, and compliance of the device with which the terminal 10′ is communicating (e.g., the television 35). The authentication may comprise one of Digital Transmission Content Protection (DTCP) full/restricted authentication protocol, or High-bandwidth Digital Content Protection (HDCP) authentication protocol, or the like.

The set of service tiers may comprise at least one of a free off-air service tier, a premium subscription service tier, a pay-per-view service tier, an on-demand service tier, or the like.

The copy protection levels may comprise at least one of an unlimited copy level, a copy once level, a copy no more level, a no copy level, or the like.

In an example implementation of the invention, a pay-per-view (PPV) tier is defined at the headend 30 to have a copy protection level of copy once. A user may tune the terminal 10′ to a PPV channel and purchase the PPV program. The terminal 10′ is connected to a digital television 35 (e.g., via an IEEE 1394 connection). The terminal 10′ then determines that the tuned channel belongs to the PPV tier and that the PPV tier has a copy protection level of copy once. The authentication subsystem 20 then authenticates the television 35. If the authentication succeeds, the terminal 10′ enables copying (via copy protection system 18) utilizing copy once encryption and passes the content to the television 35 over the IEEE 1394 connection.

FIG. 3 illustrates an example embodiment of a service tier/copy protection look-up table 40 which provides an association between service tiers 42 and copy protection levels 44. The look-up table 40 may be used by the processor 16 to associate the service tier 42 with the copy protection level 44. The look-up table 40 may be downloaded to the memory 12 of the consumer appliance 10 or loaded into memory at the time of manufacture.

The parser 14, the copy protection system 18, and the authentication subsystem 20 are shown in FIG. 1 as discrete components of the consumer appliance 10 for ease of explanation only. Those skilled in the art should appreciate that the functions of the parser 14, copy protection system 18, and authentication subsystem 20 may be provided as sets of executable instructions stored in memory (such as memory 12 or other memory), which instructions are executable by a central processing unit. The functions of the parser 14, the copy protection system 18, and the authentication subsystem 20 may be provided by processor 16 or additional processors in the consumer appliance 10.

It should now be appreciated that the present invention provides advantageous methods and apparatus for determining digital copy protection levels assigned to services received at a consumer appliance.

Although the invention has been described in connection with various illustrated embodiments, numerous modifications and adaptations may be made thereto without departing from the spirit and scope of the invention as set forth in the claims.

What is claimed is:

1. A method for determining digital copy protection levels assigned to services received at a consumer appliance, comprising:
defining a set of service tiers, each service tier being associated with one of a plurality of copy protection levels;
parsing service information from a received service to enable determination of the service tier associated with the received service;
matching the service tier of the received service with its associated copy protection level; and
enabling copy protection for the received service in accordance with the copy protection level associated with the received service.

2. A method in accordance with claim 1, wherein the consumer appliance comprises at least one of a television terminal, a digital television, a personal computer, an Internet appliance, a personal digital assistant, or a telephone.

3. A method in accordance with claim 1, wherein said service information comprises at least one of channel map information or program guide information.

4. A method in accordance with claim 1, wherein said service information is parsed when the consumer appliance is tuned to output said received service.

5. A method in accordance with claim 1, wherein said copy protection comprises at least one of Digital Transmission Content Protection (DTCP) copy protection, or High-bandwidth Digital Content Protection (HDCP) copy protection.

6. A method in accordance with claim 1, wherein:
the consumer appliance comprises a television terminal; and
the service comprises a television program.

7. A method in accordance with claim 6, wherein:
the set of service tiers is defined at one of a television headend or said consumer appliance.

8. A method in accordance with claim 7, further comprising:
establishing authentication between the television terminal and the television.

9. A method in accordance with claim 8, wherein said authentication comprises one of Digital Transmission Content Protection (DTCP) full/restricted authentication protocol, or High-bandwidth Digital Content Protection (HDCP) authentication protocol.

10. A method in accordance with claim 6, wherein said set of service tiers comprises at least one of a free off-air service tier, a premium subscription service tier, a pay-per-view service tier, or an on-demand service tier.

11. A method in accordance with claim 1, wherein said copy protection levels comprise at least one of an unlimited copy level, a copy once level, a copy no more level, or a no copy level.

12. A method in accordance with claim 1, wherein said service comprises at least one of a television program, a pay-per-view event, an on-demand program, streaming media, IP data, a downloadable software program, a song, a multimedia file, or a music video.

13. A consumer appliance enabled to determine digital copy protection levels assigned to received services, comprising:
memory for storing data defining a set of service tiers, each service tier being associated with one of a plurality of copy protection levels;
a parser for parsing service information from a received service to enable determination of the service tier associated with the received service;
a processor for matching the service tier of the received service with its associated copy protection level; and
a copy protection system for enabling copy protection for the received service in accordance with the copy protection level associated with the received service.

14. A consumer appliance in accordance with claim 13, wherein the consumer appliance comprises at least one of a television terminal, a digital television, a personal computer, an Internet appliance, a personal digital assistant, or a telephone.

15. A consumer appliance in accordance with claim 13, wherein said service information comprises at least one of channel map information or program guide information.

16. A consumer appliance in accordance with claim 13, wherein said parser parses the service information when the consumer appliance is tuned to output said received service.

17. A consumer appliance in accordance with claim 13, wherein said copy protection comprises at least one of Digital Transmission Content Protection (DTCP) copy protection, or High-bandwidth Digital Content Protection (HDCP) copy protection.

18. A consumer appliance in accordance with claim 13, wherein:
the consumer appliance comprises a television terminal; and
the service comprises a television program.

19. A consumer appliance in accordance with claim 18, wherein:
the set of service tiers is defined at one of a television headend or said consumer appliance.

20. A consumer appliance in accordance with claim 19, further comprising:
an authentication subsystem for establishing authentication between the television terminal and the television.

21. A consumer appliance in accordance with claim 20, wherein said authentication comprises one of Digital Transmission Content Protection (DTCP) full/restricted authentication protocol, or High-bandwidth Digital Content Protection (HDCP) authentication protocol.

22. A consumer appliance in accordance with claim 18, wherein said set of service tiers comprises at least one of a free off-air service tier, a premium subscription service tier, a pay-per-view service tier, or an on-demand service tier.

23. A consumer appliance in accordance with claim 13, wherein said copy protection levels comprise at least one of an unlimited copy level, a copy once level, a copy no more level, or a no copy level.

24. A consumer appliance in accordance with claim 13, wherein said service comprises at least one of a television program, a pay-per-view event, an on-demand program, streaming media, IP data, a downloadable software program, a song, a multimedia file, or a music video.
